(19) United States
(12) Patent Application Publication
(10) Pub. No.: US 2015/0001433 A1
(43) Pub. Date: Jan. 1, 2015

(54) AZEOTROPIC AND AZEOTROPE-LIKE COMPOSITIONS OF Z-1,1,1,4,4,4-HEXAFLUORO-2-BUTENE, TRANS-1,2-DICHLOROETHYLENE, AND A THIRD COMPONENT

(71) Applicant: E I DU PONT DE NEMOURS AND COMPANY, Wilmington, DE (US)

(72) Inventors: MARK L. ROBIN, MIDDLETOWN, DE (US); JOAN ELLEN BARTELT, WILMINGTON, DE (US)

(21) Appl. No.: 14/487,644

(22) Filed: Sep. 16, 2014

Related U.S. Application Data
(63) Continuation of application No. 12/823,246, filed on Jun. 25, 2010, now abandoned.
(60) Provisional application No. 61/220,673, filed on Jun. 26, 2009.

(51) Int. Cl. B01F 17/00; C09K 3/30; C09K 5/04; C09K 21/08; H01B 3/18

(52) U.S. Cl. CPC B01F 17/0035; C09K 21/08; H01B 3/18; C09K 5/04; C09K 3/30; C09K 2205/126; C09K 2205/122; C09K 2205/32
USPC 252/2; 252/581; 252/580; 252/67; 252/78.1; 252/364; 516/12; 516/8

(57) ABSTRACT

Azeotropic or azeotrope-like compositions are disclosed. The azeotropic or azeotrope-like compositions are mixtures of Z-1,1,1,4,4,4-hexafluoro-2-butene, trans-1,2-dichloroethylene and a third component. Also disclosed are compositions where the third component is cyclopentane, methanol, dimethyoxymethane, methyl formate or perfluoro ethyl isopropyl ketone. Also disclosed is a process of preparing a thermoplastic or thermoset foam by using such azeotropic or azeotrope-like compositions as blowing agents. Also disclosed is a process of producing refrigeration by using such azeotropic or azeotrope-like compositions. Also disclosed is a process of using such azeotropic or azeotrope-like compositions as solvents. Also disclosed is a process of producing an aerosol product by using such azeotropic or azeotrope-like compositions. Also disclosed is a process of using such azeotropic or azeotrope-like compositions as heat transfer media. Also disclosed is a process of extinguishing or suppressing a fire by using such azeotropic or azeotrope-like compositions. Also disclosed is a process of using such azeotropic or azeotrope-like compositions as dielectrics.

The present application claims priority to US Patent Application No. filed on Jun. 26, 2009, incorporated herein by reference, U.S. Patent Application No. 61/220,673 filed on Jun. 26, 2009, incorporated herein by reference, U.S. Patent Application No. 61/220,676 filed on Jun. 26, 2009, incorporated herein by reference, U.S. Patent Application No. 61/220,680 filed on Jul. 15, 2009, incorporated herein by reference, and U.S. Patent Application No. 61/225,627 filed on Jul. 15, 2009, incorporated herein by reference.

### BACKGROUND OF THE INVENTION

1. Field of the Disclosure

The present disclosure relates to azeotropic or azeotrope-like compositions of Z-1,1,1,4,4,4-hexafluoro-2-butene, trans-1,2-dichloroethylene, and a third component, where the trans-1,2-dichloroethylene and the third component are present in amounts effective to form an azeotropic or azeotrope like composition with th Z-1,1,1,4,4,4-hexafluoro-2-butene.

2. Description of Related Art

Many industries have been working for the past few decades to find replacements for the ozone depleting chlorofluorocarbons (CFCs) and hydrochlorofluorocarbons (HCFCs). The CFCs and HCFCs have been employed in a wide range of applications, including their use as aerosol propellants, refrigerants, cleaning agents, expansion agents for thermoplastic and thermoset foams, heat transfer media, gaseous dielectrics, fire extinguishing and suppression agents, power cycle working fluids, polymerization media, particulate removal fluids, carrier fluids, buffing abrasive agents, and displacement drying agents. In the search for replacements for these versatile compounds, many industries have turned to the use of hydrofluorocarbons (HFCs).

The HFCs do not contribute to the destruction of stratospheric ozone, but are of concern due to their contribution to the “greenhouse effect”, i.e., they contribute to global warming. As a result of their contribution to global warming, the HFCs have come under scrutiny, and their widespread use may also be limited in the future. Thus, there is a need for compositions that do not contribute to the destruction of stratospheric ozone and also have low global warming potentials (GWPs). Certain hydrofluoroolefins, such as 1,1,1,4,4,4-hexafluoro-2-butene (CF₃CH═CHCF₃, FO-1336mzz), are believed to meet both goals.

### SUMMARY OF THE INVENTION

This disclosure provides an azeotropic or azeotrope-like composition consisting essentially of (a) Z-FO-1336mzz, (b) trans-1,2-dichloroethylene (E-CICH═CHCl, trans-1,2-DCE) and (c) a third component; wherein the trans-1,2-dichloroethylene and the third component are present in effective amounts to form an azeotropic or azeotrope-like mixture with Z-FO-1336mzz.

In one embodiment of the invention, the third component of the composition is cyclopentane, methanol, perfluoro ethyl isopropyl ketone, dimethoxymethane (DMM), or methyl formate.

This disclosure also provides processes of using these azeotropic or azeotrope-like compositions as blowing agents, refrigerants, solvents, aerosol propellants, heat transfer medias, fire extinguishants, fire suppression agents or dielectrics.

### DETAILED DESCRIPTION OF THE INVENTION

In many applications, the use of a pure single component or an azeotropic or azeotrope-like mixture is desirable. For example, when a blowing agent composition (also known as foam expansion agents or foam expansion compositions) is not a pure single component or an azeotropic or azeotrope-like mixture, the composition may change during its application in the foam forming process. Such change in composition could detrimentally affect processing or cause poor performance in the application. Also, in refrigeration applications, a refrigerant is often lost during operation through leaks in shaft seals, hose connections, soldered joints and broken lines. In addition, the refrigerant may be released to the atmosphere during maintenance procedures on refrigeration equipment. If the refrigerant is not a pure single component or an azeotropic or azeotrope-like composition, the refrigerant composition may change when leaked or discharged to the atmosphere from the refrigeration equipment. The change in refrigerant composition may cause the refrigerant to become flammable or to have poor refrigeration performance. Accordingly, there is a need for using azeotropic or azeotrope-like mixtures in these and other applications, for example azeotropic or azeotrope-like mixtures containing Z-1,1,1,4,4,4-hexafluoro-2-butene (Z-CF₃CH═CHCF₃, Z-FO-1336mzz, cis-FO-1336mzz).

Before addressing details of embodiments described below, some terms are defined or clarified.

FO-1336mzz may exist as one of two configurational isomers, E or Z. FO-1336mzz as used herein refers to the isomers, Z-FO-1336mzz or E-FO-1336mzz, as well as any combinations or mixtures of such isomers.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of embodiments of the present invention, suitable methods and materials are described below. All publications, patent applications, patents, and other references mentioned herein are incorporated by reference in their entirety, unless a particular passage is cited. In case of conflict, the present specification, including definitions, will control. In addition, the materials, methods, and examples are illustrative only and not intended to be limiting.

Z-FO-1336mzz is a known compound, and its preparation method has been disclosed, for example, in U.S. Patent Publication No. 2008/0269532, hereby incorporated by reference in its entirety.

This application includes ternary azeotropic or azeotrope-like compositions consisting essentially of (a) Z-FO-1336mzz, (b) trans-1,2-dichloroethylene, and (c) a third component; wherein the trans-1,2-dichloroethylene and the third component are present in effective amounts to form an azeotropic or azeotrope-like mixture with Z-FO-1336mzz. Examples include compositions where the third component is cyclopentane, methanol, dimethyoxymethane, methyl formate or perfluoro ethyl isopropyl ketone

By effective amount is meant an amount, which, when combined with Z-FO-1336mzz, results in the formation of an azeotropic or azeotrope-like mixture. This definition includes the amounts of each component, which amounts may vary depending on the pressure applied to the composition so long as the azeotropic or azeotrope-like compositions continue to exist at the different pressures, but with possible different boiling points. Therefore, effective amount includes the amounts, such as may be expressed in weight or mole percentages, of each component of the compositions of the instant invention which form azeotropic or azeotrope-like compositions at temperatures or pressures other than as described herein.

As recognized in the art, an azeotropic composition is an admixture of two or more different components which, when in liquid form under a given pressure, will boil at a substantially constant temperature and provide a vapor composition essentially identical to the overall liquid composition undergoing boiling. (see, e.g., M. F. Doherty and M. F. Malone, Conceptual Design of Distillation Systems, McGraw-Hill (New York), 2001, 185-186, 351-359). Constant boiling compositions are characterized as azeotropic because they exhibit either a maximum or minimum boiling point of the mixture relative to the boiling points of the neat components at constant pressure, i.e., a maximum or minimum boiling point is observed in a plot of composition boiling point at a given pressure as a function of mole fraction of components in the composition. Azeotropic compositions are also characterized by a minimum or a maximum in the vapor pressure of the mixture relative to the vapor pressure of the neat components at a constant temperature, i.e., a maximum or minimum vapor pressure is observed in a plot of composition vapor pressure at a given temperature as a function of mole fraction of components in the composition.

Accordingly, the essential features of an azeotropic composition are that at a given pressure, the boiling point of the liquid composition is fixed and that the composition of the vapor above the boiling composition is essentially that of the overall boiling liquid composition (i.e., no fractionation of the components of the liquid composition takes place). It is also recognized in the art that both the boiling point and the weight percentages of each component of the azeotropic composition may change when the azeotropic composition is subjected to boiling at different pressures. Thus, an azeotropic composition may be defined in terms of the unique relationship that exists among the components or in terms of the compositional ranges of the components or in terms of exact weight percentages of each component of the composition characterized by a fixed boiling point at a specified pressure.

For the purpose of this invention, an azeotrope-like composition means a composition that behaves like an azeotropic composition (i.e., has constant boiling characteristics or a tendency not to fractionate upon boiling or evaporation). Hence, during boiling or evaporation, the vapor and liquid compositions, if they change at all, change only to a minimal or negligible extent. This is to be contrasted with non-azeotrope-like compositions in which during boiling or evaporation, the vapor and liquid compositions change to a substantial degree.

An azeotrope-like composition can also be characterized by the area that is adjacent to the maximum or minimum boiling point in a plot of composition boiling point at a given pressure as a function of mole fraction of components in the composition. Hence, another characteristic of an azeotrope-like composition is that there is a range of compositions containing the individual components in varying proportions over which the boiling point of the composition at a given pressure is substantially unchanged.

An azeotrope-like composition can also be characterized by the area that is adjacent to the maximum or minimum vapor pressure in a plot of composition vapor pressure at a given temperature as a function of mole fraction of components in the composition. Hence, another characteristic of an azeotrope-like composition is that there is a range of compositions containing the individual components in varying proportions over which the vapor pressure of the composition at a given temperature is substantially unchanged.

Additionally, azeotrope-like compositions exhibit dew point pressure and bubble point pressure with virtually no pressure differential. That is to say that the difference in the dew point pressure and bubble point pressure at a given temperature will be a small value.

It was found through experiments that Z-FO-1336mzz, trans-1,2-dichloroethylene and cyclopentane form ternary azeotropic or azeotrope-like compositions. The azeotropic composition consists essentially of about 58 weight percent of Z-1,1,1,4,4,4-hexafluoro-2-butene, about 22 weight percent of trans-1,2-dichloroethylene, and about 20 weight percent of cyclopentane. It has the boiling point of about 29° C. at about atmospheric pressure (14.7 psia). The azeotrope-like composition consists essentially of from about 34 to about 70 weight percent of 2-1,1,1,4,4,4-hexafluoro-2-butene, from about 13 to about 27 weight percent of trans-1,2-dichloroethylene, and from about 2 to about 53 weight percent of cyclopentane. It has a boiling point of from about 29° C. to about 30° C. at a pressure of about 14.7 psia.

It was found through experiments that Z-FO-1336mzz, trans-1,2-dichloroethylene and perfluoro ethyl isopropyl ketone form ternary azeotropic or azeotrope-like compositions. The azeotropic composition has the boiling point of about 30° C. at about atmospheric pressure (14.7 psia). The azeotrope-like compositions consist essentially of from about 36 to about 72 weight percent of Z-1,1,1,4,4,4-hexafluoro-2-butene, from about 14 to about 28 weight percent of trans-1,2-dichloroethylene, and from about 1 to about 50 weight percent of perfluoro ethyl isopropyl ketone and have a boiling point of about 30° C. at a pressure of about 14.7 psia.

It was found through experiments that Z-FO-1336mzz, trans-1,2-dichloroethylene and methanol form ternary azeotropic or azeotrope-like compositions. The azeotropic composition consists essentially of about 70 weight percent of Z-1,1,1,4,4,4-hexafluoro-2-butene, about 27 weight percent of trans-1,2-dichloroethylene, and about 3 weight percent of methanol. It has the boiling point of about 29° C. at about atmospheric pressure (14.7 psia). The azeotrope-like composition consists essentially of from about 60 to about 72 weight percent of Z-1,1,1,4,4,4-hexafluoro-2-butene, from about 23 to about 28 weight percent of trans-1,2-dichloroethylene, and from about 1 to about 16 weight percent of methanol. It has a boiling point of from about 29° C. to about 31° C. at a pressure of about 14.7 psia.

It was found through experiments that Z-FO-1336mzz, methyl formate and trans-1,2-dichloroethylene form ternary azeotrope-like compositions. The azeotrope-like composition consists essentially of from about 18 to about 60 weight percent of Z-1,1,1,4,4,4-hexafluoro-2-butene, from about 17 to about 64 weight percent of methyl formate, and from about 18 to about 23 weight percent of trans-1,2-dichloroethylene. It has a boiling point of about 31° C. at a pressure of about 14.7 psia.

It was found through experiments that Z-FO-1336mzz, dimethoxymethane and trans-1,2-dichloroethylene form ternary azeotrope-like compositions. The azeotrope-like composition consists essentially of from about 1 to about 47 weight percent of Z-1,1,1,4,4,4-hexafluoro-2-butene, from about 35 to about 99 weight percent of dimethoxymethane, and from about 1 to about 18 weight percent of trans-1,2-dichloroethylene. It has a boiling point of about 41° C. at a pressure of about 14.7 psia.

The azeotropic or azeotrope-like compositions of the present invention can be prepared by any convenient method including mixing or combining the desired amounts. In one embodiment of this invention, an azeotropic or azeotrope-like composition can be prepared by weighing the desired component amounts and thereafter combining them in an appropriate container.

The azeotropic or azeotrope-like compositions of the present invention can be used in a wide range of applications, including their use as aerosol propellants, refrigerants, solvents, cleaning agents, blowing agents (foam expansion agents) for thermoplastic and thermoset foams, heat transfer media, gaseous dielectrics, fire extinguishing and suppression agents, power cycle working fluids, polymerization media, particulate removal fluids, carrier fluids, buffing abrasive agents, and displacement drying agents.

One embodiment of this invention provides a process for preparing a thermoplastic or thermoset foam. The process comprises using an azeotropic or azeotrope-like composition as a blowing agent, wherein said azeotropic or azeotrope-like composition consists essentially of (a) Z-1,1,1,4,4,4-hexafluoro-2-butene, (b) trans-1,2-dichloroethylene, and (c) a third component, wherein the trans-1,2-dichloroethylene and the third component are present in effective amounts to form an azeotropic or azeotrope-like combination with the Z-1,1,1,4,4,4-hexafluoro-2-butene.

Another embodiment of this invention provides a process for producing refrigeration. The process comprises condensing an azeotropic or azeotrope-like composition and thereafter evaporating said azeotropic or azeotrope-like composition in the vicinity of the body to be cooled, wherein said azeotropic or azeotrope-like composition consists essentially of (a) Z-1,1,1,4,4,4-hexafluoro-2-butene, (b) trans-1,2-dichloroethylene, and (c) a third component, wherein the trans-1,2-dichloroethylene and the third component are present in effective amounts to form an azeotropic or azeotrope-like combination with the Z-1,1,1,4,4,4-hexafluoro-2-butene.

Another embodiment of this invention provides a process using an azeotropic or azeotrope-like composition as a solvent, wherein said azeotropic or azeotrope-like composition consists essentially of (a) Z-1,1,1,4,4,4-hexafluoro-2-butene, (b) trans-1,2-dichloroethylene, and (c) a third component, wherein the trans-1,2-dichloroethylene and the third component are present in effective amounts to form an azeotropic or azeotrope-like combination with the Z-1,1,1,4,4,4-hexafluoro-2-butene.

Another embodiment of this invention provides a process for producing an aerosol product. The process comprises using an azeotropic or azeotrope-like composition as a propellant, wherein said azeotropic or azeotrope-like composition consists essentially of (a) Z-1,1,1,4,4,4-hexafluoro-2-butene, (b) trans-1,2-dichloroethylene, and (c) a third component, wherein the trans-1,2-dichloroethylene and the third component are present in effective amounts to form an azeotropic or azeotrope-like combination with the Z-1,1,1,4,4,4-hexafluoro-2-butene.

Another embodiment of this invention provides a process using an azeotropic or azeotrope-like composition as a heat transfer media, wherein said azeotropic or azeotrope-like composition consists essentially of (a) Z-1,1,1,4,4,4-hexafluoro-2-butene, (b) trans-1,2-dichloroethylene, and (c) a third component, wherein the trans-1,2-dichloroethylene and the third component are present in effective amounts to form an azeotropic or azeotrope-like combination with the Z-1,1,1,4,4,4-hexafluoro-2-butene.

Another embodiment of this invention provides a process for extinguishing or suppressing a fire. The process comprises using an azeotropic or azeotrope-like composition as a fire extinguishing or suppression agent, wherein said azeotropic or azeotrope-like composition consists essentially of (a) Z-1,1,1,4,4,4-hexafluoro-2-butene, (b) trans-1,2-dichloroethylene, and (c) a third component, wherein the trans-1,2-dichloroethylene and the third component are present in effective amounts to form an azeotropic or azeotrope-like combination with the Z-1,1,1,4,4,4-hexafluoro-2-butene.

Another embodiment of this invention provides a process using an azeotropic or azeotrope-like composition as dielectrics, wherein said azeotropic or azeotrope-like composition consists essentially of (a) Z-1,1,1,4,4,4-hexafluoro-2-butene, (b) trans-1,2-dichloroethylene, and (c) a third component, wherein the trans-1,2-dichloroethylene and the third component are present in effective amounts to form an azeotropic or azeotrope-like combination with the Z-1,1,1,4,4,4-hexafluoro-2-butene.

Many aspects and embodiments have been described above and are merely exemplary and not limiting. After reading this specification, skilled artisans appreciate that other aspects and embodiments are possible without departing from the scope of the invention.

### EXAMPLES

The concepts described herein will be further described in the following examples, which do not limit the scope of the invention described in the claims. Unless otherwise stated therein, all percentages are by weight.

### Example 1

### Cyclopentane

Example 1 demonstrates the existence of azeotropic or azeotrope-like compositions formed by Z-1,1,1,4,4,4-hexafluoro-2-butene, trans-1,2-dichloroethylene and cyclopentane. An ebulliometer equipped with a thermometer was charged with 20.0 grams of a mixture (72.1 wt % Z-1,1,1,4,4,4-hexafluoro-2-butene and 27.9 wt % trans-1,2-dichloroethylene) and then cyclopentane was added in measured increments. The boiling point temperatures of the resultant ternary mixtures at about 14.7 psia were measured and recorded (see Table 1). Temperature depression was observed when cyclopentane was added to the Z-FO-1336mzz/trans-1,2-DCE mixture, indicating a ternary minimum boiling azeotrope was formed. At about atmopsheric pressure (14.7 psia) the ternary azeotropic composition was found to have about 20 weight percent cyclopentane, about 58 weight percent Z-FO-1336mzz and about 22 weight percent trans-1,2-DCE and have a boiling point of about 29° C. From about 2 to about 53 weight percent cyclopentane the boiling points of the resultant ternary mixtures changed by about 1° C. or less. These compositions hence exhibited azeotrope-like properties over this range.

TABLE 1
Boiling Points of Z-FO-1336mzz/trans-1,2-DCE/Cyclopentane
Mixtures at 14.7 psia

| | wt % Z-FO- | wt % trans-1,2- | |
|---|---|---|---|
| wt % Cyclopentane | 1336mzz | DCE | Temperature (° C.) |
| 2.14 | 70.46 | 27.40 | 30.0 |
| 7.12 | 66.87 | 26.01 | 29.6 |
| 12.46 | 63.03 | 24.51 | 29.3 |
| 15.69 | 60.70 | 23.61 | 29.2 |
| 19.41 | 58.02 | 22.56 | 29.1 |
| 23.47 | 55.10 | 21.43 | 29.1 |
| 27.71 | 52.05 | 20.24 | 29.2 |
| 32.01 | 48.95 | 19.04 | 29.3 |
| 35.83 | 46.20 | 17.97 | 29.4 |
| 41.95 | 41.79 | 16.25 | 29.7 |
| 45.42 | 39.30 | 15.28 | 29.8 |
| 48.98 | 36.74 | 14.29 | 29.9 |
| 46.32 | 38.65 | 15.03 | 30.1 |
| 50.90 | 35.36 | 13.75 | 30.2 |
| 53.07 | 33.79 | 13.14 | 30.4 |

### Example 2

### Methyl Formate

Example 2 demonstrates the existence of azeotrope-like compositions formed by Z-1,1,1,4,4,4-hexafluoro-2-butene, methyl formate and trans-1,2-dichloroethylene. An ebulliometer equipped with a thermometer was charged with 20.0 grams of a mixture (72.1 wt % Z-1,1,1,4,4,4-hexafluoro-2-butene and 27.9 wt % trans-1,2-dichloroethylene) and then methyl formate was added in measured increments. The boiling point temperatures of the resultant ternary mixtures at about 14.7 psia were measured and recorded (see Table 2). From about 17 to about 64 weight percent methyl formate the boiling points of the resultant ternary mixtures were unchanged. The compositions hence exhibit azeotrope-like properties over this range.

TABLE 2
Boiling Points of Z-FO-1336mzz/trans-1,2-DCE/Methyl formate
Mixtures at 14.7 psia

| wt % Methyl | wt % | | |
|---|---|---|---|
| formate | Z-FO-1336mzz | wt % trans-1,2-DCE | Temperature (C.) |
| 16.92 | 59.82 | 23.26 | 31.4 |
| 24.25 | 54.54 | 21.21 | 31.4 |
| 27.45 | 52.24 | 20.31 | 31.4 |
| 31.77 | 49.13 | 19.10 | 31.4 |
| 34.37 | 47.25 | 18.38 | 31.4 |
| 51.52 | 34.05 | 14.43 | 31.4 |
| 53.52 | 31.50 | 14.99 | 31.4 |
| 56.90 | 27.17 | 15.93 | 31.4 |
| 60.38 | 22.72 | 16.91 | 31.4 |
| 63.72 | 18.44 | 17.84 | 31.4 |

### Example 3

### Methanol

Example 3 demonstrates the existence of azeotropic or azeotrope-like compositions formed by Z-1,1,1,4,4,4-hexafluoro-2-butene, trans-1,2-dichloroethylene and methanol. An ebulliometer equipped with a thermometer was charged with 20.0 grams of a mixture (72.1 wt % Z-1,1,1,4,4,4-hexafluoro-2-butene and 27.9 wt % trans-1,2-dichloroethylene) and then methanol was added in measured increments. The boiling point temperatures of the resultant ternary mixtures at about 14.7 psia were measured and recorded (see Table 3). Temperature depression was observed when methanol was added to the Z-FO-1336mzz/trans-1,2-DCE mixture, indicating a ternary minimum boiling azeotrope was formed. At about atmopsheric pressure (14.7 psia) the ternary azeotropic composition was found to have about 3 weight percent methanol, about 70 weight percent Z-FO-1336mzz and about 27 weight percent trans-1,2-DCE and have a boiling point of about 29° C. From about 1 to about 16 weight percent methanol the boiling points of the resultant ternary mixtures changed by about 2° C. or less. These compositions hence exhibited azeotrope-like properties over this range.

TABLE 3
Boiling Points of Z-FO-1336mzz/trans-1,2-DCE/Methanol Mixtures at
14.7 psia

| | Wt % Z-FO- | | Temperature |
|---|---|---|---|
| Wt % Methanol | 1336mzz | Wt % trans-1,2-DCE | ° C. |
| 0.00% | 72.00% | 28.00% | 30.00 |
| 1.17% | 71.16% | 27.67% | 29.10 |
| 3.43% | 69.53% | 27.04% | 29.10 |
| 4.53% | 68.74% | 26.73% | 29.30 |
| 5.59% | 67.97% | 26.43% | 29.50 |
| 6.64% | 67.22% | 26.14% | 29.60 |
| 8.66% | 65.77% | 25.58% | 29.60 |
| 9.64% | 65.06% | 25.30% | 29.80 |
| 11.53% | 63.70% | 24.77% | 30.20 |
| 13.35% | 62.39% | 24.26% | 30.60 |
| 14.23% | 61.75% | 24.02% | 30.80 |
| 15.09% | 61.13% | 23.77% | 30.90 |
| 15.94% | 60.52% | 23.54% | 31.00 |

### Example 4

### Perfluor Ethyl Isopropyl Ketone

Example 4 demonstrates the existence of azeotropic or azeotrope-like compositions formed by Z-1,1,1,4,4,4-hexafluoro-2-butene (Z-FO-1336mzz), trans-1,2-dichloroethylene (trans-1,2-DCE) and perfluoro ethyl isopropyl ketone (F-ethyl isopropyl ketone). An ebulliometer equipped with a thermometer was charged with 20.0 grams of a mixture (72.1 wt % Z-1,1,1,4,4,4-hexafluoro-2-butene and 27.9 wt % trans-1,2-dichloroethylene) and then perfluoro ethyl isopropyl ketone was added in measured increments. The boiling point temperatures of the resultant ternary mixtures at about 14.7 psia were measured and recorded (see Table 1). From about 1 to about 50 weight percent perfluoro ethyl isopropyl ketone the boiling points of the resultant ternary mixtures changed by about 1° C. or less. These compositions hence exhibited azeotrope-like properties over this range.

TABLE 4
Boiling Points of Z-FO-1336mzz/trans-1,2-DCE/F-Ethyl
Isopropyl Ketone Mixtures at 14.7 psia

| wt % | wt % | wt % | Temperature |
|---|---|---|---|
| F-ethyl isopropyl ketone | Z-FO-1336mzz | trans-1,2-DCE | (° C.) |
| 2.3 | 70.3 | 27.3 | 30.3 |
| 8.8 | 65.7 | 25.5 | 29.9 |
| 12.6 | 62.9 | 24.5 | 29.8 |
| 16.1 | 60.4 | 23.5 | 29.6 |
| 20.9 | 57.0 | 22.2 | 29.6 |
| 25.1 | 53.9 | 21.0 | 29.8 |
| 29.0 | 51.1 | 19.9 | 29.7 |
| 36.5 | 45.7 | 17.8 | 29.9 |
| 43.4 | 40.7 | 15.8 | 30.1 |
| 47.7 | 37.7 | 14.6 | 30.4 |
| 51.9 | 34.6 | 13.5 | 30.6 |

### Example 5

### DMM

Example 5 demonstrates the existence of azeotrope-like compositions formed by Z-1,1,1,4,4,4-hexafluoro-2-butene (Z-FO-1336mzz), dimethoxymethane (DMM) and trans-1,2-dichloroethylene (trans-1,2-DCE). An ebulliometer equipped with a thermometer was charged with 20.0 grams of a mixture (72.1 wt % Z-1,1,1,4,4,4-hexafluoro-2-butene and 27.9 wt % trans-1,2-dichloroethylene) and then dimethoxymethane was added in measured increments. The boiling point temperatures of the resultant ternary mixtures at about 14.7 psia were measured and recorded (Table 5). From about 35 to about 99 weight percent dimethoxymethane the boiling points of the resultant ternary mixtures were changed by less than about 2° C. The compositions hence exhibit azeotrope-like properties over this range.

TABLE 5
Boiling Points of Z-FO-1336mzz/DMM/trans-1,2-DCE Mixtures
at 14.7 psia

| | | | Temperature |
|---|---|---|---|
| wt % DMM | wt % Z-FO-1336mzz | wt % trans-1,2-DCE | (° C.) |
| 36.2 | 45.9 | 17.9 | 40.3 |
| 38.2 | 44.5 | 17.3 | 40.4 |
| 39.7 | 43.4 | 16.9 | 40.5 |
| 42.7 | 41.3 | 16.1 | 40.9 |
| 50.0 | 36.0 | 14.0 | 41.1 |
| 100.0 | 0.0 | 0.0 | 42.3 |

1. An azeotropic composition consisting essentially of:
(a) Z-1,1,1,4,4,4-hexafluoro-2-butene;
(b) trans-1,2-dichloroethylene; and
(c) a third component; wherein the trans-1,2-dichloroethylene and the third component are present in effective amounts to form an azeotropic combination with the Z-1,1,1,4,4,4-hexafluoro-2-butene wherein the third component is:
(i) cyclopentane and the composition has a boiling point of about 29 C at a pressure of about 14.7 psia
(i) perfluoro ethyl isopropyl ketone and the composition has a boiling point of about 30 C at a pressure of about 14.7 psia; or

[symbol]

2. (canceled)

3. (canceled)

4. An azeotrope-like composition consisting essentially of:
(a) Z-1,1,1,4,4,4-hexafluoro-2-butene;
(b) trans-1,2-dichloroethylene; and
(c) a third component, wherein the trans-1,2-dichloroethylene and the third component are present in effective amounts to form an azeotropic-like combination with the Z-1,1,1,4,4,4-hexafluoro-2-butene wherein the third component is
(i) from about 2 to about 53 weight percent cyclopentane, the Z-1,1,1,4,4,4-hexafluoro-2-butene is from about 34 to about 70 weight percent, and the trans-1,2-dichloroethylene is from about 13 to about 27 weight percent;
(ii) from about 17 to about 64 weight percent methyl formate, the Z-1,1,1,4,4,4-hexafluoro-2-butene is from about 18 to about 60 weight percent, and the trans-1,2-dichloroethylene is from about 18 to about 23 weight percent;
(iv) from about 1 to about 50 weight percent perfluoro ethyl isopropyl ketone, the Z-1,1,1,4,4,4-hexafluoro-2-butene is from about 36 to about 72 weight percent, and the trans-1,2-dichloroethylene is from about 14 to about 28 weight percent; or
(v) from about 35 to about 99 weight dimethoxymethane, the Z-1,1,1,4,4,4-hexafluoro-2-butene is from about 1 to about 47 weight percent, and the trans-1,2-dichloroethylene is from about 1 to about 18 weight percent.

5. (canceled)

6. (canceled)

7. The azeotrope-like composition of claim 4, wherein the composition is an aerosol propellant, refrigerant, solvent, cleaning agent, foam expansion agent for thermoplastic or thermoset foam, heat transfer media, gaseous dielectrics, fire extinguishing and suppression agents, power cycle working fluids, polymerization media, particulate removal fluids, carrier fluids, buffing abrasive agents, or displacement drying agent.

8. The azeotropic composition of claim 1, wherein the composition is an aerosol propellant, refrigerant, solvent, cleaning agent, foam expansion agent for thermoplastic or thermoset foam, heat transfer media, gaseous dielectrics, fire extinguishing and suppression agents, power cycle working fluids, polymerization media, particulate removal fluids, carrier fluids, buffing abrasive agents, or displacement drying agent.
